(19) United States
(12) Patent Application Publication
(10) Pub. No.: US 2016/0259980 A1
(43) Pub. Date: Sep. 8, 2016

(54) SYSTEMS AND METHODOLOGIES FOR PERFORMING INTELLIGENT PERCEPTION BASED REAL-TIME COUNTING

(71) Applicant: Umm Al-Qura University, Makkah (SA)

(72) Inventors: Ehab MLYBARI, Makkah (SA); AbdelRahman Hedar, Makkah (SA); Gamal Elsayed, Makkah (SA); Esam Yosry, Makkah (SA); Alaa E. Abdelhakim, Makkah (SA); Moussa Elbissy, Makkah (SA); Amr Gadelrab, Makkah (SA)

(73) Assignee: Umm Al-Qura University, Makkah (SA)

(21) Appl. No.: 15/060,173

(22) Filed: Mar. 3, 2016

Related U.S. Application Data
(60) Provisional application No. 62/127,813, filed on Mar. 3, 2015.

(51) Int. Cl. G06K 9/00; G06T 11/60; G06K 9/66; G06K 9/62; G06T 7/20; G06T 7/00

(52) U.S. Cl. CPC G06K 9/00778; G06T 7/204; G06K 9/00335; G06T 7/0044; G06T 7/0079; G06K 9/00718; G06K 9/66; G06K 9/6256; G06T 11/60; G06K 9/6267; G06T 2207/30242; G06T 2207/30196; G06T 2207/20144; G06T 2207/20224

(57) ABSTRACT

Systems and methods are provided for people counting. The method includes acquiring video data from one or more sensors and learning parameters associated with the one or more sensors. The method further includes detecting one or more objects and extracting learned features from each of the one or more objects. The learned features are identified based on the learning parameters. The method further include detecting, using the processing circuitry and based on the learned features, one or more individuals from the one or more objects. Then, the one or more individuals are tracked based on a filter. The method further includes updating a people counter as a function of a position of each tracked individual.

### CROSS REFERENCE

This application claims the benefit of priority from U.S. Provisional Application No. 62/127,813 filed Mar. 3, 2015, the entire contents of which are incorporated herein by reference.

### BACKGROUND

People counting is an application of detection of moving objects and motion-based tracking. There is an increasing interest in tracking applications in real-time. People counting may be required in highly crowded places where hundreds of thousands of individuals may be gathered. Examples include sporting events, shopping centers, concerts, marathons, schools, and religious gatherings such as Hajj.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention. The foregoing paragraph has been provided by way of general introduction, and is not intended to limit the scope of the following claims. The described embodiments, together with further advantages, will be best understood by reference to the following detailed description taken in conjunction with the accompanying drawings.

### SUMMARY

According to an embodiment of the present disclosure, there is provided a method for people counting. The method includes acquiring video data from one or more sensors and learning parameters associated with the one or more sensors. The method further includes detecting one or more objects and extracting learned features from each of the one or more objects. The learned features are identified based on the learning parameters. The method further include detecting, using the processing circuitry and based on the learned features, one or more individuals from the one or more objects. Then, the one or more individuals are tracked based on a filter. The method further includes updating a people counter as a function of a position of each tracked individual.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a system for people detection, people tracking, and people counting according to one example;

FIG. 2 is a schematic that shows a convolutional neural network (CNN) architecture according to one example;

FIG. 3 is a flow chart illustrating a method for determining learning parameters according to one example;

FIG. 4 is a flow chart illustrating a method for performing intelligent real-time counting according to one example;

FIG. 5 is a schematic that shows a graphical user interface according to one example;

FIG. 6 is an exemplary block diagram of a computer according to one example;

FIG. 7 is an exemplary block diagram of a data processing system according to one example; and

FIG. 8 is an exemplary block diagram of a central processing unit according to one example.

### DETAILED DESCRIPTION

Referring now to the drawings, wherein like reference numerals designate identical or corresponding parts throughout several views, the following description relates to systems and associated methodologies for real-time people detection, people tracking, and people counting in a crowd.

People tracking can be aimed at estimating locations of moving target objects in video sequences. However, the performance and the efficiency of tracking algorithms have challenges. It is challenging to develop a set of standard approaches that are appropriate for a diverse variety of applications as described in W. You, M. S. Houari Sabirin, and M. Kim, “Real-time detection and tracking of multiple objects with partial decoding in H.264/AVC bit stream domain”, Proceedings of SPIE, Vol. 7244, (2009), the entirety of which is herein incorporated by reference. As an example, it is challenging to develop a tracking algorithm that find the spatial location of a target object, while being invariant to different variations in imaging conditions (e.g., variations in light, noise from the camera). There are further issues associated with people tracking in crowded places, for example, inter-object occlusion and separation and difficulties of detecting some Muslim clothing (e.g., the case of the two Holy Mosques). Due to these issues, contextual information of moving objects may be lost which results in tracking uncertainties.

A field of view (FOV) of a captured image data may be divided into a set of blocks. An object detection and tracking system for tracking a blob through the FOV and a learning system are disclosed in U.S. Pat. No. 7,991,193 B2 entitled “AUTOMATED LEARNING FOR PEOPLE COUNTING SYSTEMS,” the entirety of which is herein incorporated by reference. The learning system maintains person size parameters for each block and updates the person size parameters for a selected block. However, blob size parameter may not be enough in many crowded cases where occlusion may take place. In addition, the object detection and tracking system cannot handle simultaneous bidirectional counting (e.g., people leaving and entering at the same time).

An approach that detects objects crossing a virtual boundary line is disclosed in U.S. Pat. No. 8,165,348 B2 entitled “DETECTING OBJECTS CROSSING A VIRTUAL BOUNDARY LINE,” the entirety of which is herein incorporated by reference.

A second approach for moving targets tracking and counting in poor imaging conditions (e.g., unbalanced illumination) and at different times (e.g., daylight, night), and in gesture variations is disclosed in U.S. patent application 2010/0021009 A1 entitled “METHOD FOR MOVING TARGETS TRACKING AND NUMBER COUNTING,” the entirety of which is herein incorporated by reference. However, the second approach only uses image segmentation with no other input source, without a correction mechanism such as artificial intelligence (AI) techniques. Moreover, the second approach does not handle counting people in crowded or occlusion situations.

The methodology described herein may be applied to live images sequences captured by surveillance video cameras. Analysis can be performed in real-time using a computer while the surveillance video cameras are capturing a live crowded environment. In one example, the methodologies described herein may be applied to the analysis of recorded or time-delayed videos.

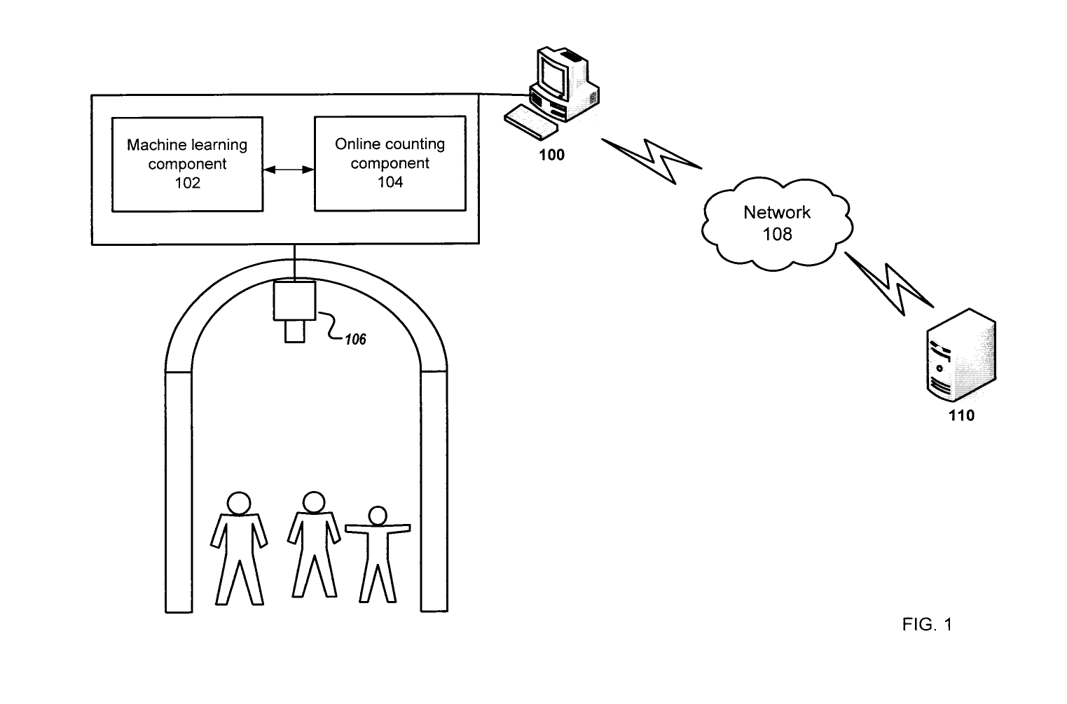

FIG. 1 is a block diagram of a system for people detection, people tracking, and people counting according to one example. The system may include one or more input sources, for example, one or more video cameras 106. The one or more video cameras 106 may send live camera feeds, connected via a coaxial cable, a USB (Universal serial bus), FireWire, or wirelessly to one or more video capture cards hosted in a computer 100, which may be located locally, for example near the entrance to the two Holy Mosques. The one or more video cameras 106 may be mounted above a field of vision (FOV) through which people pass. The system may be deployed at entrance gates as a core component of crowd management systems. The system may be employed in a training mode or in a real-time counting mode. The one or more video cameras 106 may include IP (Internet protocol) cameras, CCTV (closed circuit television) cameras, IR (infrared) cameras, or other sensors as would be understood by one of ordinary skill in the art.

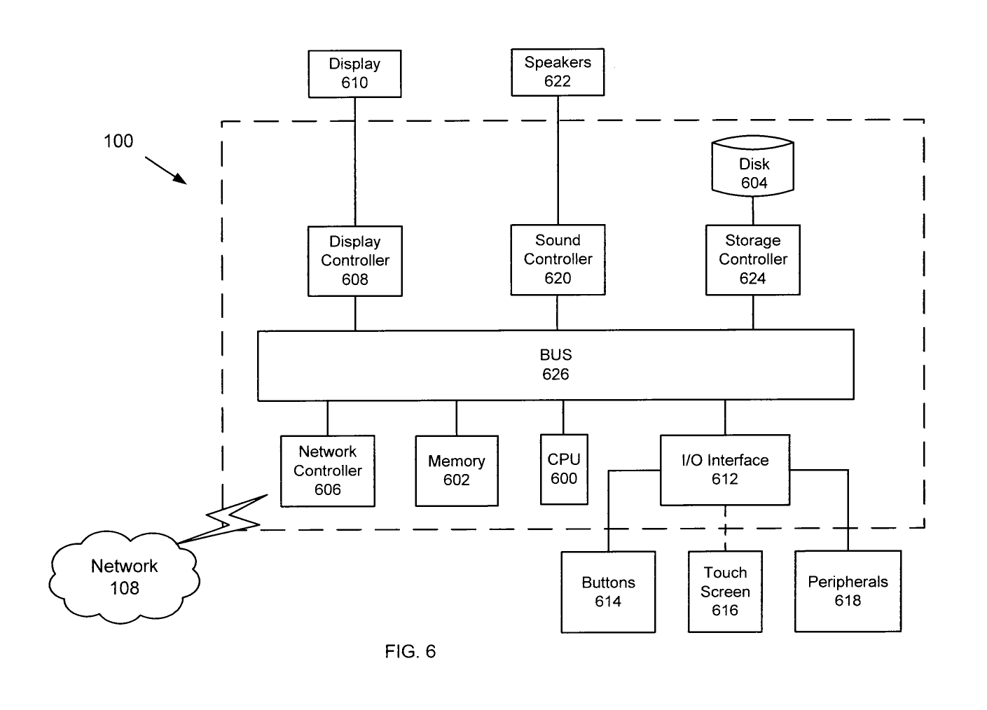

The system may include a machine-learning component 102 and an online counting component 104. The machine-learning component 102 develops an intelligent method for people counting based on learning suitable data mining and computer vision techniques. The online counting component 104 performs real-time people counting as a function of learned people count setup (e.g., learning parameters) obtained from the machine-learning component 102. The system includes one or more software processes executed on hardware. For example, the one or more processes described herein can be executed by processing circuitry of at least one computer (e.g., computer 100). The computer 100 may include a CPU 600 and a memory 602, as shown in FIG. 6.

The machine-learning component 102 and the online counting component 104 may include visual feature extraction functions (e.g., global feature extraction, local feature extraction), image change characterization functions, information fusion functions, density estimation functions, and automatic learning functions.

Output data from the machine-learning component 102 and the online counting component 104 may be transmitted via a network 108, for the example, to a remote database including a web server 110 from which information may be accessed and visualized, via the network 102.

The crowd may include individuals with special wears (e.g., hijab, security guards, Islamic Burqa). The machine-learning component 102 includes features learning via intelligent machine learning algorithms. In one example, deep learning and convolutional Neural Networks (CNN) are applied for features learning.

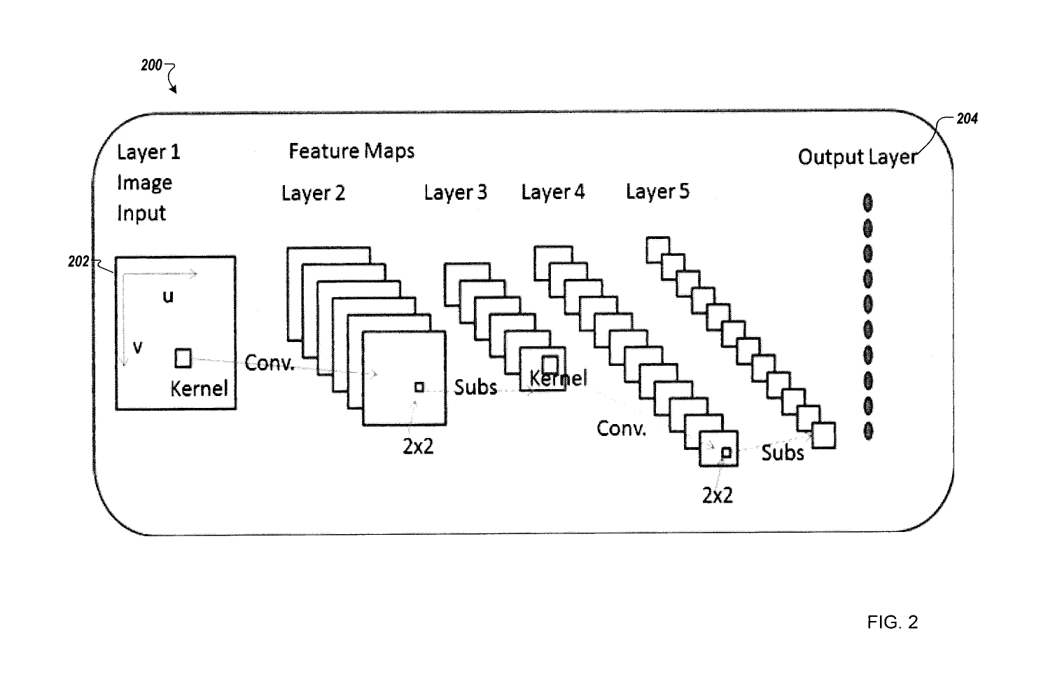

FIG. 2 is a schematic that shows a convolutional neural network (CNN) architecture 200 according to one example. Like many biologically inspired models, CNN is a biologically inspired variant of multilayer perceptron (MLP). As noticed from cats' visual cortex, CNN contains sophisticated arrangements of cells, which are sensitive to sub-regions of the receptive field. So, CNN is constructed to contain filters over an input layer image 202 to benefit from the local spatial correlation of the natural images. Therefore, the input layer image 202 is convolved with an overlapping sliding kernel to produce feature maps. Then, subsampling and convolution are repeatedly performed to produce hidden layers, which are the feature maps, until reaching a fully connected MLP output layer 204.

For example, the machine-learning component 102 may apply the method described in in N. Fabian, C. Thurau, and G. Fink, “Face detection using gpu-based convolutional neural networks,” in Computer Analysis of Images and Patterns, (2009), which is herein incorporated by reference. As described above, the CNN classifies an input pattern by a set of several concatenated operations (e.g., convolutions, subsamplings, and full connections). The net may include a predetermined number of successive layers starting from the input layer, each subsequent layer consist of several fields of the same size (as the input layer) which represent the intermediate results within the net. Each directed edge stands for a particular operation which is applied on a field of a preceding layer and the result is stored into another field of a successive layer. In the case that more than one edge directs to a field, the results of operations may be summed. After each layer, a bias is added to every pixel and the result is passed through a sigmoid function, to perform a mapping onto an output variable. Each convolution may use a different two-dimensional set of filter coefficients. For subsampling operations a simple method may be used which halves the dimension of an image by summing up the values of disjunct sub-images and weighting each result value with the same factor. The term “full connection” describes a function, in which each output value is the weighted sum over all input values. A full connection can be described as a set of convolutions where each field of the preceding layer is connected with every field of the successive layer and the filters have the same size as the input image.

The MLP output layer 204 represents a confidence measure of belonging of the input instance to a certain class. CNN was used for face detection as described in N. Fabian, C. Thurau, and G. Fink, “Face detection using gpu-based convolutional neural networks,” in Computer Analysis of Images and Patterns, (2009), M. Oquab, L. Bottou, I. Laptev, and J. Sivic, “Is object localization for free? Weakly supervised learning with convolutional neural networks,” In proceedings of the IEEE Conference on Computer Vision and Pattern Recognition, (2015), and M. Matsugu and P. Cardon, “Unsupervised feature selection for multi-class object detection using convolutional neural networks,” In Advances in Neural Networks, 2004, the entirety of each herein being incorporated by reference.

However, a common paradigm to detect objects is to run the object detector on sub-images and exhaustively pass it over all possible locations and scales in the input image as described in P. F. Felzenzwalb, R. B. Girshick, D. McAllester, and D. Ramanan, “Object detection with discriminatively trained part-based models”, Patterns Analysis and Machine Intelligence, IEEE, (2010), which is herein incorporated by reference.

The computational challenges were solved by a “DeepMultiBox” detector, as described in D. Erhan, C. Szegedy, A. Toshev, and D. Anguelov, “Scalable object detection using deep neural networks,” In computer vision and patter recognition, (2014), which is herein incorporated by reference. The object detection problem is defined as a regression problem by generating bounding boxes for object candidates by a single CNN in a class-agnostic manner.

In one example, the “DeepMultiBox” paradigm may be adopted. Individual subjects are detected as objects using a regression model for a single class, which is a “person”.

A Deep Neural Network (DNN) may be used. The DNN outputs a fixed number of bounding boxes. In addition, the DNN outputs a score for each box expressing the network confidence of this box containing an object. Each object box and its associated confidence are encoded as node values of the last net layer. The upper-left and lower-right coordinates of each box are encoded as four node values. The upper-left and lower-right coordinates are normalized with respect to image dimensions to achieve invariance to absolute image size. Each normalized coordinate is produced by a linear transformation of the last hidden layer. The confidence score for the box containing an object is encoded as a single node value. The single node value is produced through a linear transformation of the last hidden layer followed by a sigmoid. The bounding box locations are combined as one linear layer. Collection of all confidences may be considered as the output. The output layers are connected to the last hidden layers. The DNN may be trained to predict bounding boxes and associated confidence scores for each training image (frame from the videos) such that he highest scoring boxes match well the ground truth object boxes for the image.

Let xᵢⱼ∈{0,1} denote an assignment xᵢⱼ=1 if the i-th prediction is assigned to j-th true object. The objective of the assignment can be expressed as:

$${F}_{match} ( x , l ) = \frac{1}{2} {\sum }_{i , j} {x}_{ij} {‖ {l}_{i} - {g}_{i} ‖}_{2}^{2} \qquad ( 1 )$$

where L₂ is the distance between the normalized bounding box coordinates to quantify the dissimilarity between bounding boxes. The confidences of the boxes are optimized. Maximizing the confidences of assigned predictions can be expressed as:

$${F}_{conf} ( x , c ) = \frac{1}{2} {\sum }_{i , j} {x}_{ij} log ( {c}_{i} ) - {\sum }_{i} ( 1 - {\sum }_{j} {x}_{ij} ) log ( 1 - {c}_{i} ) \qquad ( 2 )$$

Objective Σⱼxᵢⱼ=1 if prediction i has been matched to a groundtruth. In that case cᵢ is being maximized, while in the opposite case it is being minimized. The final loss objective combines the matching and confidence losses and may be expressed as:

F(x, l, c)=αF_{match}(x, l)+F_{conf}(x, c) (3)

subject to constraints in Equation (1). a balances the contribution of the different loss terms. For each training, the optimal assignment x* of prediction to true boxes may be solved using:

$$\begin{matrix}{x}^{*} = arg {min}_{x} F ( x , l , c ) \\ subject to & ( 4 ) \\ {x}_{ij} ∈ \{ 0 , 1 \} , {\sum }_{i} {x}_{ij} = 1 & ( 5 )\end{matrix}$$

where the constraints enforce an assignment solution. This is a variant of bipartite matching, which is polynomial in complexity. The network parameters are optimized via back-propagation. For example, the first derivatives of the back-propagation algorithm are computed with respect to l and c:

$$\begin{matrix}\frac{\partial F}{\partial {l}_{i}} = {\sum }_{j} ( {l}_{i} - {g}_{i} ) {x}_{ij}^{*} & ( 6 ) \\ \frac{\partial F}{\partial {c}_{i}} = \frac{{\sum }_{j} {x}_{ij}^{*} {c}_{i}}{{c}_{i} ( 1 - {c}_{i} )} & ( 7 )\end{matrix}$$

In other examples, multi-class detection may be used to refine categories of the detected individual subjects like security guards, handicapped, or children. The refined categories provide a helpful tool in big gathering fields to determine more detailed information about the nature of the existing mass.

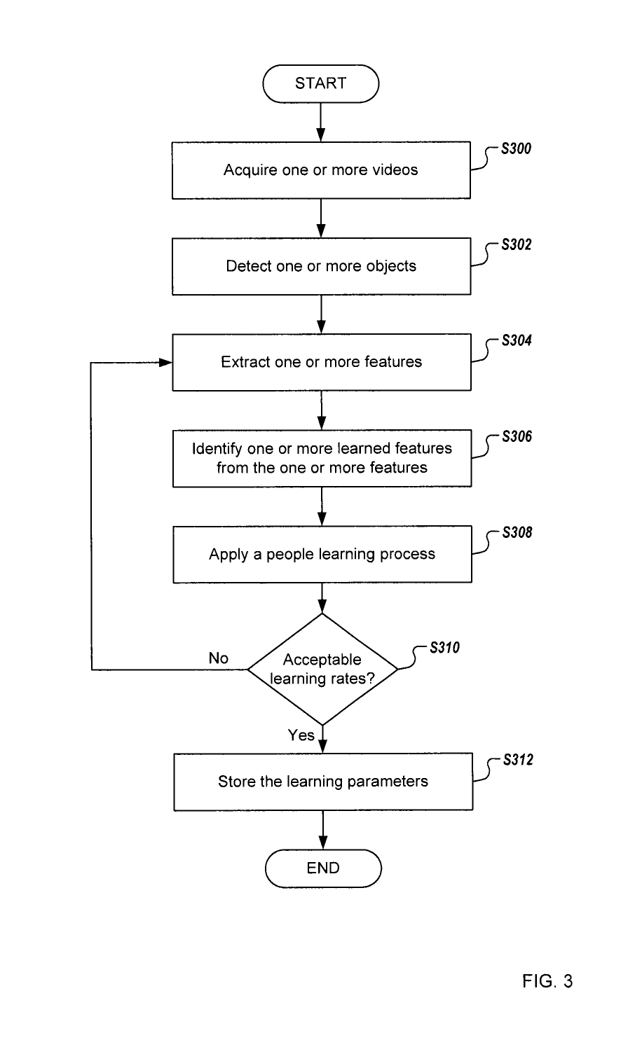

FIG. 3 is a flow chart illustrating a method for determining learning parameters according to one example. At step S300, the CPU 600 may acquire one or more videos from the input source. The input source may include one or more cameras. The one or more videos include a footage of people moving. Then, a training set is selected from the one or more videos. The training is selected to include a wide set of crowd levels. The training set includes extreme levels of crowdedness (e.g., very crowded to low crowded). In addition, the training set includes video data of individuals with predetermined wear.

At step S302, the CPU 600 detects objects in the one or more videos. In one example, a background subtraction algorithm may be used to detect moving objects. The background subtraction algorithm may be a function of Gaussian mixture models as would be understood by one of ordinary skill in the art. Each pixel's intensity may be modeled using a Gaussian mixture model. Then, a heuristic algorithm determines which intensities are most probably of the background. The pixels that do not match to the background intensities are identified as the foreground pixels (foreground mask). Morphological operations (e.g., erosion, dilation, closing, opening, hit and miss transform) are applied, by the CPU 600, on the foreground mask to eliminate noise. Then, groups of connected pixels (objects) are detected using a blob detection method (e.g., Laplacian of Gaussian, Difference of Gaussians, Determinant of Hessian). In one example, the CPU 600 may detects the objects using DNN as previously described herein.

At step S304, the CPU 600 performs feature extraction on the detected objects to extract informative and non-redundant features. Then, at step S306, the CPU 600 may identify one or more learned features using a feature learning process.

Feature learning is the process of selecting the most relevant features among a set of features based on learning processes methods. Learning processes identify and remove irrelevant and/or useless features from a set of features to reduce its size. The selected or reduced feature set can be more effectively analyzed and used in further recognition processes. Methods for feature learning include, but are not limited to, artificial neural networks, deep learning, genetic programming, granular computing, evolutionary computation, probabilistic heuristics, and metaheuristic programming. The extensive learning process is applied to decide which visual human features should be extracted in order to identify them.

In one example, the CPU 600 applies a hybrid technique. The hybrid technique includes applying a granular computing process (e.g., fuzzy and rough sets) for modelling and evaluations, and applying deep learning and meta-heuristics for feature searching. Features includes, but are not limited to, head, shoulders, head peaks, covered head, western wear, Muslim wear, and Asian wear.

At step S308, a learning process may be applied to detect individuals from the moving objects. The CPU 600 analyzes the learned features to identify individual among detected moving objects. Extreme cases of interfering objects, occlusion, and people with special wears are also identified during the learning process. The learning process aims at increasing the accuracy of the vision-based detecting system while minimizing processing in the real-time mode.

In one example, collected input images (frames from the one or more videos) are normalized with respect to size. Accordingly, a preprocessing stage can be utilized. The preprocessing stage primarily includes an edge detector in order to direct the learning algorithm towards the contours, silhouettes, and objects edges. The preprocessing stage is based on the contours and silhouettes of objects playing a major role in distinguishing human subjects in the image. However, various preprocessing procedures may be used for the supervised final estimate in other examples. The output of the preprocessing stage acts as the input to a CNN. The function of the CNN is to learn the most relevant features for the detection problem as described previously herein.

At step S310, the CPU 600 may check to see whether the learning rates are acceptable. In response to determining that the learning rates are acceptable, the flow goes to step S312. In response to determining that the learning rates are not acceptable, the flow goes back to step S304. The CPU 600 may determine whether the learning rates are not acceptable by comparing the learnings rates with predetermined thresholds. For example, the CPU 600 may compare a first learning rate indicating the learning rate for people detection with a first predetermined threshold stored in the memory 602.

At step S312, the setting for the learned features and for the people detection (learning parameters) are stored in the memory 602. In one example, the settings may also be uploaded to the server 110 via the network 108.

In one embodiment, the system described herein may be used for counting the number of non-humans. Thus, the learning features are different from those of humans.

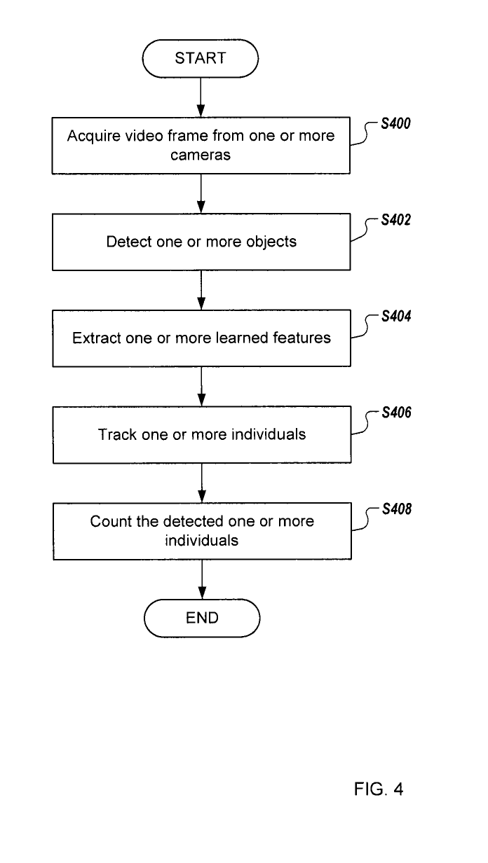

FIG. 4 is a flow chart illustrating a method for people counting according to one example. At step S400, the CPU 600 may acquire one or more video frames from the one or more cameras. The video frames are received in real time from the cameras for real-time people counting.

At step S402, the CPU 600 detects one or more objects as described in step S302. At step S404, the learned features are extracted from the one or more objects detected at step S402. The CPU 600 detects individuals using the settings of the machine learning features stored at step S312.

At step S406, the CPU 600 tracks one or more individuals. The association of detections to the same object is based on motion. A Kalman filter may be used to estimate the motion of each track. The Kalman filter is used to predict the track's location in each frame and determine the likelihood of each detection being assigned to each track. Other filters may be applied such as extended Kalman filter, unscented Kalman filter, a Kalman-Bucy filter or the like.

At step S408, the CPU 600 may determine the spatial location of the centroid of each blob from frame to frame using a blob velocity vector algorithm. Then, the CPU 600 may determine the direction from which the centroid is approaching a virtual reference line (e.g., a virtual tripwire). A people count is updated (e.g., increment, decrement) as a function of the direction of a movement of the track (e.g., exiting or entering a building).

In one example, a first counter may be updated as a function of a first direction and a second counter may be updated as a function of a second direction opposite to the first direction.

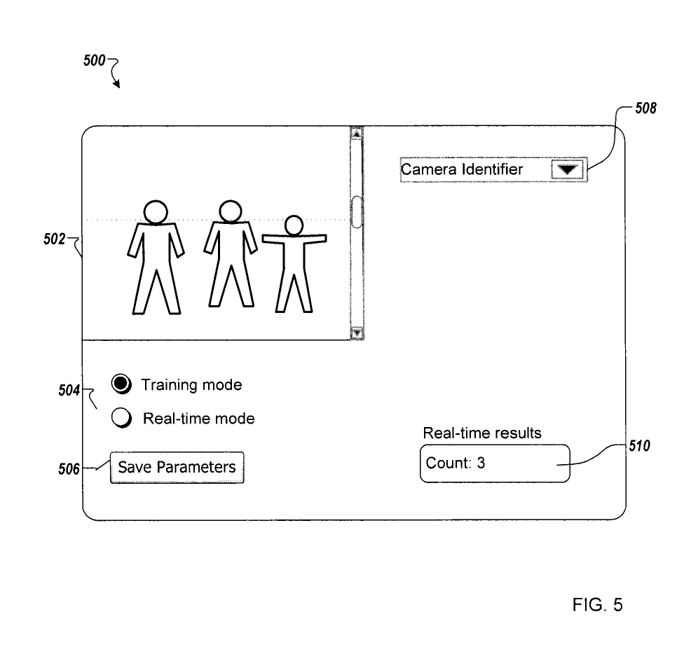

The virtual reference line may be of arbitrary shape, which may be user-defined and may be integrated into the one or more frames using video processing techniques as would be understood by one of ordinary skill in the art. In one example, the user may define the virtual reference line using the graphical user interface shown in FIG. 5.

In the real-time mode, the system can continue to update the learning parameters using the methodology described in FIG. 3. Thus, the system may re-compute and adjust the learned features in real-time.

In one example, count data may be uploaded to the server 110. Count data from a plurality of systems located at different gates may be processed in the sever 110. For example, a building may have a plurality of entrances each equipped with the system described herein. The server 110 may acquire data from each of the plurality of entrances and analyze the data to determine, in a real-time, a total people count for the building.

In one example, video frames from each of the plurality of entrances are uploaded to the server 110. The server 110 then process the video frames using the methodologies described herein to obtain a total count. The server 110 may store learning parameters for a plurality of locations. For example, each video camera (or other input source) may be associated with a geographic location identified using longitudinal and latitude coordinates. The geographic location of each video camera along with a unique camera identifier may be stored in the server 110.

In one example, metadata received with the one or more videos may indicate the unique camera identifier. Then, the server 110 may use a look-up table to retrieve the learning parameters associated with the unique camera identifier.

In one example, the learning parameters may be associated with predetermined times. For example, an entrance may be restricted to predetermined individuals (e.g., entrance to a mosque may be restricted to woman at predetermined times), thus using learning parameters associated with the predetermined times may improve the accuracy of the real-time count.

In one example, an external device may access the server 110 and/or the computer 100 to obtain a people count at a specific location. For example, a user may check the crowd level at the specific location. The external device may include a computer, a tablet a smartphone or the like.

FIG. 5 is a schematic that shows a graphical user interface 500 according to one example. The GUI 500 may be a part of a website, web portal, personal computer application, or mobile application configured to allow users to interact with the computer 100 and/or server 110. The GUI 500 may include an image area 502 for displaying the FOV, buttons 504 for selecting the mode of operation of the system (e.g., training mode, real-time mode), a “save parameters” button 506 for storing the learning parameters, and a “select camera” control 508. Upon activation of the “select camera” control 508, the user may be presented with a drop-down menu, search box, or other selection control for identifying the video camera. In one example, when the system include a single input system the camera identifier is automatically selected. A “result” pane 510 may show the people count when in a “Real-time” mode. A scroll bar 512 is for selecting the virtual line. An additional “share” control (not shown), when selected, presents the user with options to share (e.g., email, print) results and/or parameters with the external device.

Next, a hardware description of the computer 100 according to exemplary embodiments is described with reference to FIG. 6. In FIG. 6, the computer 100 includes a CPU 600 which performs the processes described herein. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 100 communicates, such as the server 110.

Further, the claimed advancements may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

In order to achieve the computer 100, the hardware elements may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The computer 100 in FIG. 6 also includes a network controller 606, such as an Intel Ethernet PRO network interface card from Intel Corporation of America, for interfacing with network 108. As can be appreciated, the network 108 can be a public network, such as the Internet, or a private network such as LAN or WAN network, or any combination thereof and can also include PSTN or ISDN sub-networks. The network 108 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer 100 further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as an optional touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the computer 100, such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the computer 100. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

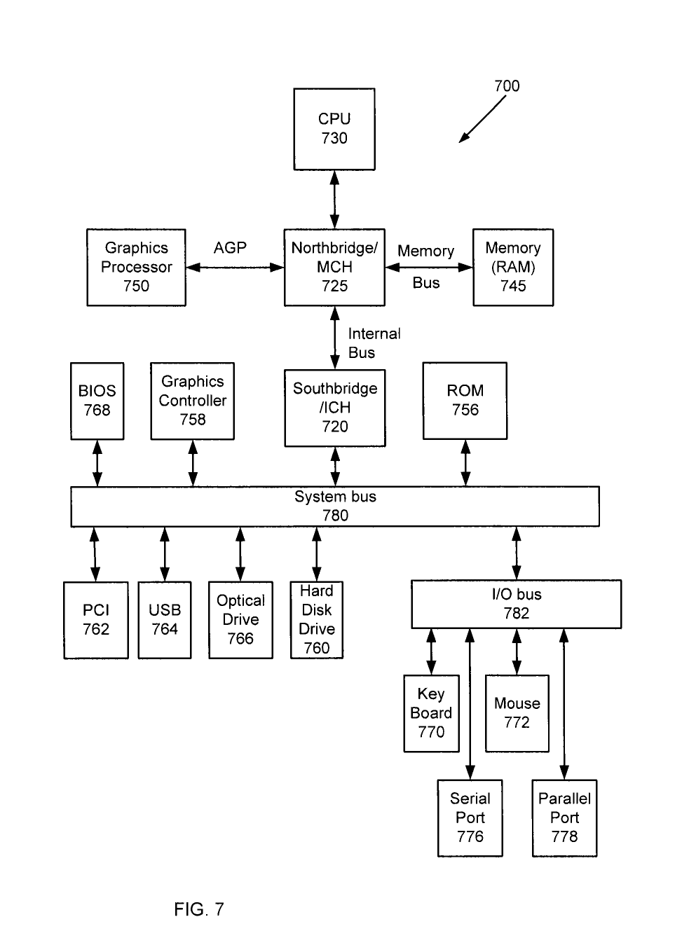

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in the circuitry on a single chipset, as shown on FIG. 7.

FIG. 7 shows a schematic diagram of a data processing system, according to certain embodiments, for performing people detection, people tracking, and people counting utilizing the methodologies described herein. The data processing system is an example of a computer in which specific code or instructions implementing the processes of the illustrative embodiments may be located to create a particular machine for implementing the above-noted process.

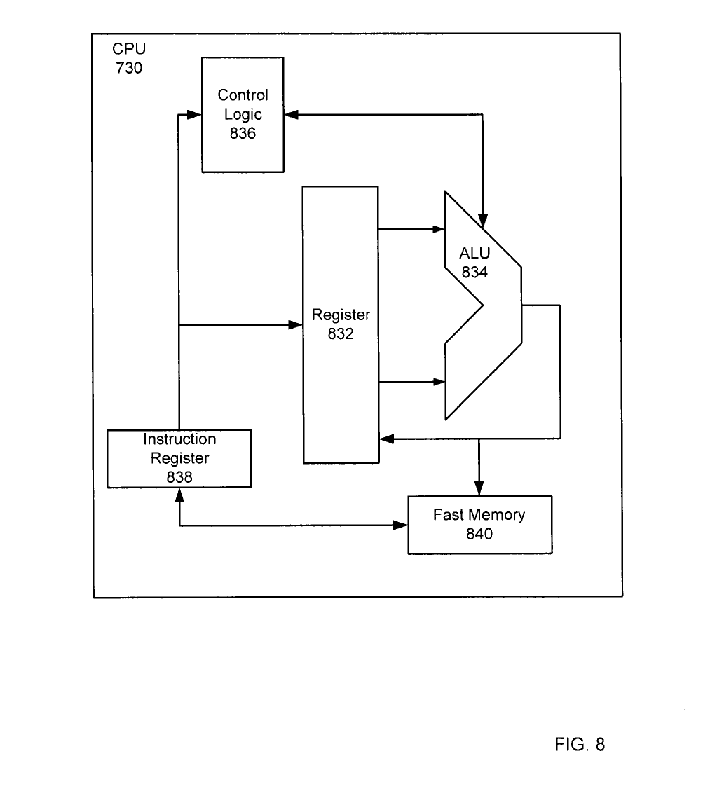

In FIG. 7, data processing system 700 employs a hub architecture including a north bridge and memory controller hub (NB/MCH) 725 and a south bridge and input/output (I/O) controller hub (SB/ICH) 720. The central processing unit (CPU) 730 is connected to NB/MCH 725. The NB/MCH 725 also connects to the memory 745 via a memory bus, and connects to the graphics processor 750 via an accelerated graphics port (AGP). The NB/MCH 725 also connects to the SB/ICH 720 via an internal bus (e.g., a unified media interface or a direct media interface). The CPU 730 may contain one or more processors and may even be implemented using one or more heterogeneous processor systems. For example, FIG. 8 shows one implementation of CPU 730.

Further, in the data processing system 700 of FIG. 7, SB/ICH 720 is coupled through a system bus 780 to an I/O Bus 782, a read only memory (ROM) 756, an universal serial bus (USB) port 764, a flash binary input/output system (BIOS) 768, and a graphics controller 758. In one implementation, the I/O bus can include a super I/O (SIO) device.

PCI/PCIe devices can also be coupled to SB/ICH 720 through a PCI bus 762. The PCI devices may include, for example, Ethernet adapters, add-in cards, and PC cards for notebook computers. Further, the hard disk drive (HDD) 760 and optical drive 766 can also be coupled to the SB/ICH 720 through the system bus 780. The Hard disk drive 760 and the optical drive or CD-ROM 766 can use, for example, an integrated drive electronics (IDE) or serial advanced technology attachment (SATA) interface.

In one implementation, a keyboard 770, a mouse 772, a serial port 776, and a parallel port 778 can be connected to the system bus 780 through the I/O bus 782. Other peripherals and devices that can be connected to the SB/ICH 720 include a mass storage controller such as SATA or PATA (Parallel Advanced Technology Attachment), an Ethernet port, an ISA bus, a LPC bridge, SMBus, a DMA controller, and an Audio Codec (not shown).

In one implementation of CPU 730, the instruction register 838 retrieves instructions from the fast memory 840. At least part of these instructions are fetched from the instruction register 838 by the control logic 836 and interpreted according to the instruction set architecture of the CPU 730. Part of the instructions can also be directed to the register 832. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 834 that loads values from the register 832 and performs logical and mathematical operations on the loaded values according to the instructions. The results from these operations can be feedback into the register and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor, a Power architecture processor by, e.g., IBM; a SPARC architecture processor by Sun Microsystems or by Oracle; or other known CPU architecture.

The present disclosure is not limited to the specific circuit elements described herein, nor is the present disclosure limited to the specific sizing and classification of these elements.

The functions and features described herein may also be executed by various distributed components of a system. For example, one or more processors may execute these system functions, wherein the processors are distributed across multiple components communicating in a network. The distributed components may include one or more client and server machines, which may share processing in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 6 or 7, constitutes or includes specialized corresponding structure that is programmed or configured to perform the algorithms shown in FIGS. 3 and 4.

A system which includes the features in the foregoing description provides numerous advantages to users. In particular, a real-time system for people counting is essential for evacuation plan generation in highly crowded places to avoid stampedes. In addition, the system described herein may be employed in stores, museums, exhibition halls, gymnasiums, and the like. In addition, the system handles counting people with ordinary and/or visually challenging wears.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

The above disclosure also encompasses the embodiments listed below.

(1) A method including acquiring video data from one or more sensors; acquiring learning parameters associated with the one or more sensors, wherein the learning parameters are previously generated; detecting, using processing circuitry, one or more objects; extracting, using the processing circuitry, learned features from each of the one or more objects, wherein the learned features are identified based on the learning parameters; detecting, using the processing circuitry and based on the learned features, one or more individuals from the one or more objects; tracking, using the processing circuitry and based on a filter, the one or more individuals; and updating, using the processing circuitry, a people counter as a function of a position of each tracked individual.

(2) The method of feature (1), further including acquiring one or more videos from a sensor; identifying a set from the one or more videos, wherein the set includes videos representing extrema levels of crowdedness; subtracting a background to detect one or more moving objects; extracting features from the one or more moving objects; applying a people learning process to determine the learning parameters associated with the sensor; and storing the learning parameters.

(3) The method of feature (2), in which extracting the features is a function of a hybrid technique.

(4) The method of feature (3), in which the hybrid technique includes at least one of a granular computing process and a deep learning and meta-heuristics process.

(5) The method of any one of features (2) to (4), further including determining whether a predetermined condition is met; and repeating the extracting and applying steps until the predetermined condition is met.

(6) The method of feature (5), in which determining whether the predetermined condition is met includes comparing a learning rate with a predetermined learning rate.

(7) The method of any one of features (2) to (6), in which the people learning process is based on a convolutional neural network.

(8) The method of any one of features (2) to (7), in which the set includes videos of individuals with predetermined wear.

(9) The method of any one of features (1) to (8), further including applying a multiclass regression model to detect predetermined categories of the one or more individuals.

(10) The method of any one of features (1) to (9), further including defining a virtual line in a field of view of the video data; determining a movement direction of each tracked individual; and updating the people counter as a function of the virtual line and the movement direction of each tracked individual.

(11) The method of any one of features (1) to (10), in which the learning features are acquired based on metadata information received with the video data and wherein the metadata indicates a unique sensor identifier of the one or more sensors.

(12) The method of any one of features (1) to (11), in which the crowd includes individuals with predetermined wear.

(13) The method of any one of features (1) to (12), in which the learned features include feature associated with Muslim wear.

(14) The method of any one of features (1) to (13), in which the learning parameters are associated with predetermined times.

(15) A system for people counting, the system including one or more sensors; and processing circuitry configured to acquire video data from the one or more sensors, acquire learning parameters associated with the one or more sensors, detect one or more objects, extract learned features from each of the one or more objects, wherein the learned features are identified based on the learning parameters, detect one or more individuals from the one or more objects based on the learned features, track the one or more individuals based on a filter, and update a people counter as a function of a position of each tracked individual.

(16) The system of feature (15), in which the processing circuitry is further configured to acquire one or more videos from a sensor; identify a set from the one or more videos, wherein the set includes videos representing extrema levels of crowdedness; subtract a background to detect one or more moving objects; extract features from the one or more moving objects; apply a people learning process to determine the learning parameters associated with the sensor; and store the learning parameters.

(17) The system of feature (16), in which the features are extracted as a function of a hybrid technique.

(18) The system of feature (17), in which the hybrid technique includes at least one of a granular computing process and a deep learning and meta-heuristics process.

(19) The system of any one of features (16) to (18), in which the processing circuitry is further configured to determine whether a predetermined condition is met; and repeat the extracting and applying steps until the predetermined condition is met.

(20) The system of feature (19), in which the processing circuitry is further configured to compare a learning rate with a predetermined learning rate.

(21) The system of any one of features (15) to (20), in which the people learning process is based on a convolutional neural network.

(22) The system of any one of features (15) to (21), in which the set includes videos of individuals with predetermined wear.

(23) The system of any one of features (15) to (22), in which the processing circuitry is further configured to include applying a multiclass regression model to detect predetermined categories of the one or more individuals.

(24) The system of any one of features (15) to (23), in which the processing circuitry is further configured to define a virtual line in a field of view of the video data; determine a movement direction of each tracked individual; and update the people counter as a function of the virtual line and the movement direction of each tracked individual.

(25) The system of any one of features (15) to (24), in which the processing circuitry is configured to acquire the learning features based on metadata information received with the video data and wherein the metadata indicates a unique sensor identifier of the one or more sensors.

(26) The system of any one of features (15) to (25), in which the crowd includes individuals with predetermined wear.

(27) The system of any one of features (15) to (26), in which the learned features include feature associated with Muslim wear.

(28) The system of any one of features (15) to (27), in which the learning parameters are associated with predetermined times.

(29) A non-transitory computer-readable medium storing instructions, which when executed by at least one processor cause the at least one processor to perform the method of any of features (1) to (14).

1. A method comprising:
acquiring video data from one or more sensors;
acquiring learning parameters associated with the one or more sensors, wherein the learning parameters are previously generated;
detecting, using processing circuitry, one or more objects;
extracting, using the processing circuitry, learned features from each of the one or more objects, wherein the learned features are identified based on the learning parameters;
detecting, using the processing circuitry and based on the learned features, one or more individuals from the one or more objects;
tracking, using the processing circuitry and based on a filter, the one or more individuals; and
updating, using the processing circuitry, a people counter as a function of a position of each tracked individual.

2. The method of claim 1, further comprising:
acquiring one or more videos from a sensor;
identifying a set from the one or more videos, wherein the set includes videos representing extrema levels of crowdedness;
subtracting a background to detect one or more moving objects;
extracting features from the one or more moving objects;
applying a people learning process to determine the learning parameters associated with the sensor; and
storing the learning parameters.

3. The method of claim 2, wherein extracting the features is a function of a hybrid technique.

4. The method of claim 3, wherein the hybrid technique includes at least one of a granular computing process and a deep learning and meta-heuristics process.

5. The method of claim 2, further comprising:
determining whether a predetermined condition is met; and
repeating the extracting and applying steps until the predetermined condition is met.

6. The method of claim 5, wherein determining whether the predetermined condition is met includes comparing a learning rate with a predetermined learning rate.

7. The method of claim 2, wherein the people learning process is based on a convolutional neural network.

8. The method of claim 2, wherein the set includes videos of individuals with predetermined wear.

9. The method of claim 1, further comprising:
applying a multiclass regression model to detect predetermined categories of the one or more individuals.

10. The method of claim 1, further comprising:
defining a virtual line in a field of view of the video data;
determining a movement direction of each tracked individual; and
updating the people counter as a function of the virtual line and the movement direction of each tracked individual.

11. The method of claim 1, wherein the learning features are acquired based on metadata information received with the video data and wherein the metadata indicates a unique sensor identifier of the one or more sensors.

12. The method of claim 1, wherein the crowd includes individuals with predetermined wear.

13. The method of claim 1, wherein the learned features include features associated with Muslim wear.

14. The method of claim 1, wherein the learning parameters are associated with predetermined times.

15. A system for people counting, the system comprising:
one or more sensors; and
processing circuitry configured to
acquire video data from the one or more sensors,
acquire learning parameters associated with the one or more sensors,
detect one or more objects,
extract learned features from each of the one or more objects, wherein the learned features are identified based on the learning parameters,
detect one or more individuals from the one or more objects based on the learned features,
track the one or more individuals based on a filter, and
update a people counter as a function of a position of each tracked individual.

16. The system of claim 15, wherein the processing circuitry is further configured to:
acquire one or more videos from a sensor;
identify a set from the one or more videos, wherein the set includes videos representing extrema levels of crowdedness;
subtract a background to detect one or more moving objects;
extract features from the one or more moving objects;
apply a people learning process to determine the learning parameters associated with the sensor; and
store the learning parameters.

17. The system of claim 16, wherein the features are extracted as a function of a hybrid technique.

18. The system of claim 17, wherein the hybrid technique includes at least one of a granular computing process and a deep learning and meta-heuristics process.

19. A non-transitory computer readable medium storing computer-readable instructions therein which when executed by a computer cause the computer to perform a method for people counting, the method comprising:
acquiring video data from one or more sensors;
acquiring learning parameters associated with the one or more sensors;
detecting one or more objects;
extracting learned features from each of the one or more objects, wherein the learned features are identified based on the learning parameters;
detecting one or more individuals from the one or more objects based on the learned features;
tracking the one or more individuals based on a filter; and
updating a people counter as a function of a position of each tracked individual.
